(19) United States
(12) Patent Application Publication
(10) Pub. No.: US 2008/0317936 A1
(43) Pub. Date: Dec. 25, 2008

(54) Health-enhancing ethnic salad dressing

(76) Inventor: Cecille R. Magliba, Madera, CA (US)

Correspondence Address: RICHARD L. MILLER, 12 PARKSIDE DRIVE, DIX HILLS, NY, 11746, US

(21) Appl. No.: 11/821,233

(22) Filed: Jun. 22, 2007

(51) Int. Cl. A23L 1/223; A23L 1/224

(52) U.S. Cl. 426/638

(57) ABSTRACT

A health-enhancing ethnic salad dressing. The dressing includes in no particular order water, vegetable/olive oil, distilled vinegar, corn syrup, chili powder, crushed red pepper, salt, dried garlic, dried onion, dried red pepper, lemon juice concentrate, and spices.

### BACKGROUND OF THE INVENTION

A. Field of the Invention

The embodiments of the present invention relate to a salad dressing, and more particularly, the embodiments of the present invention relate to a health-enhancing ethnic salad dressing.

B. Description of the Prior Art

Numerous innovations for salad dressings have been provided in the prior art. Even though these innovations may be suitable for the specific individual purposes to which they address, however, they differ from the embodiments of the present invention in that they do not teach a health-enhancing ethnic salad dressing.

(1) U.S. Pat. No. 2,221,957 to Straub.

U.S. Pat. No. 2,221,957 issued to Straub on Nov. 19, 1940 in class 99 and subclass 144 teaches a salad dressing including honey and vegetable oil. The honey is in sufficient quantity relative to the oil to eliminate the corny and mealy taste of the oil but insufficient to mask the presence of the oil.

(2) U.S. Pat. No. 4,352,832 to Wood et al.

U.S. Pat. No. 4,352,832 issued to Wood et al. on Oct. 5, 1982 in class 426 and subclass 589 teaches dressing products that are bacteriologically-stable at room temperature and which possess a pH of at least 4.2 are prepared utilizing a relatively low level of acetic acid in combination with soluble buffering salts, such as sodium acetate and/or sodium citrate. The acetic acid level of the dressing product will be from about 0.2% to 4.0% by weight of the aqueous phase contained in the composition and the buffer salt level will be from about 0.4% to 3.0% by weight of the aqueous phase.

(3) U.S. Pat. No. 5,914,146 to Vallejo.

U.S. Pat. No. 5,914,146 issued to Vallejo on Jun. 22, 1999 in class 426 and subclass 506 teaches a salsa formulation including a tomato component, a whole pepper component, a whole spice component, and a powdered spice component. The whole pepper component includes raw banana peppers, serrano peppers, and jalapeno peppers that are boiled until soft and light green in color to release spicy oils contained in the pepper seeds that are not normally released when the peppers are ingested raw. The boiled peppers are de-stemmed and mixed with the tomato component, whole spice component, and powdered spice component, and then blended at high speed until a paste consistency is reached.

(4) U.S. Pat. No. Des. 426,469 to Mankowski et al.

U.S. Pat. No. Des. 426,469 issued to Mankowski et al. on Jun. 13, 2000 in class D9 and subclass 541 teaches an ornamental design for a salad dressing bottle.

(5) U.S. Pat. No. 6,165,537 to Carr.

U.S. Pat. No. 6,165,537 issued to Carr on Dec. 26, 2000 in class 426 and subclass 602 teaches a method for preparing a food compound, and particularly a salad dressing, including providing preselected quantities of a tomato-based product and a vegetable oil, combining the tomato-based product with the vegetable oil and heating to a temperature of about 100° to 160° F., stirring the combined mixture substantially simultaneously with heating while making certain it does not come to a boil, adding sugar to the heated combined mixture and blending thoroughly until the sugar is dissolved, refrigerating the mixture so obtained for about 2-5 hours at a temperature of about 36° to 46° F., adding preselected quantities of vinegar, a vegetable-based sauce, and onion to the refrigerated mixture and mixing for about 15 seconds to 4 minutes, and refrigerating the mixture again at a temperature of about 36° to 46° F. The food compound is prepared from a blend of natural ingredients.

(6) U.S. Pat. No. 6,245,375 to Kuil et al.

U.S. Pat. No. 6,245,375 issued to Kuil et al. on Jun. 12, 2001 in class 426 and subclass 573 teaches a translucent dressing that can be manufactured and offered to the consumer as a two-phase system, having separate oil and water layers. Upon shaking by hand, an emulsion is produced remaining stable for at least one week. The dressing is suitable for use on, e.g., salad.

(7) U.S. Pat. No. 6,329,012 to Carr. U.S. Pat. No. 6,329,012 issued to Carr on Dec. 11, 2001 in class 426 and subclass 602 teaches a method for preparing a food compound, and particularly a salad dressing, including providing preselected quantities of a tomato-based product and a vegetable oil, combining the tomato-based product with the vegetable oil and heating to a temperature of about 100° to 160° F., stirring the combined mixture substantially simultaneously with heating while making certain it does not come to a boil, adding sugar to the heated combined mixture and blending thoroughly until the sugar is dissolved, refrigerating the mixture so obtained for about 2-5 hours at a temperature of about 36° to 46° F., adding preselected quantities of vinegar, a vegetable-based sauce, and onion to the refrigerated mixture and mixing for about 15 seconds to 4 minutes, and refrigerating the mixture again at a temperature of about 36° to 46° F. The food compound is prepared from a blend of natural ingredients.

It is apparent that numerous innovations for salad dressings have been provided in the prior art that are adapted to be used. Furthermore, even though these innovations may be suitable for the specific individual purposes to which they address, however, they would not be suitable for the purposes of the present invention as heretofore described, namely, a health-enhancing ethnic salad dressing.

### SUMMARY OF THE INVENTION

Thus, it is an object of the embodiments of the present invention to provide a health-enhancing ethnic salad dressing, which avoids the disadvantages of the prior art.

Briefly stated, another object of the embodiments of the present invention is to provide a health-enhancing ethnic salad dressing. The dressing includes in no particular order water, vegetable/olive oil, distilled vinegar, corn syrup, chili powder, crushed red pepper, salt, dried garlic, dried onion, dried red pepper, lemon juice concentrate, and spices.

The novel features considered characteristic of the embodiments of the present invention are set forth in the appended claims. The embodiments of the present invention themselves, however, both as to their construction and to their method of operation together with additional objects and advantages thereof will be best understood from the following description of the specific embodiments when read and understood in connection with the accompanying drawing.

### DETAILED DESCRIPTION OF THE PREFERRED EMBODIMENTS

A. The General Composition.

A health-enhancing ethnic salad dressing comprises in particular order:
a) water;
b) vegetable/olive oil;
c) distilled vinegar;
d) corn syrup;
e) chili powder;
f) crushed red pepper;
g) salt;
h) dried garlic/onion/red pepper;
i) lemon juice concentrate; and
j) spices.

B. Vegetable Oil.¹ ¹See www.natural-health-information-centre.co,/vegetable-oil.html.

Much has been written about the benefits of replacing animal fats in the diet with vegetable oil and vegetable-derived fats.

(1) The Definition of Vegetable Oils.

Vegetable oils are used all the time, but very few vegetables would be considered as “oily”, with the possible exception of olives and avocados.

Actually, “vegetable oil” is the name usually given to any oil product derived from a plant of any description, be it fruit, vegetable, or anything else. Some oils, such as olive oil, are derived from the fruits of the plant. Others, like sunflower oil or peanut oil are pressed from the seeds. Still others, such as herb oils, are usually extracted from the leaves or roots, often using steam or another heat source to aid the process.

Some oils, such as those extracted from herbs and plant roots, are thought by many to have direct medical effects. Usually these oils are very potent and are used in minute quantities, diluted with other oils or lotions, as in aromatherapy. These essential oils are also the basis for virtually all of the fragrances and perfumes widely available.

In more general terms though, vegetable oils are the oils used in the kitchen whether it be as a component of salad dressing, the batter for cakes and pastries, or the liquid used for frying.

(2) The Health Effects of Vegetable Oils.

In general, vegetable oils are considered to be healthier than fats derived from animals. This is largely thanks to the efforts of commercial vegetable oil producers to link the modern problems of cancer and heart disease with animal fat—especially saturated fat—consumption.

Pure vegetable oils, such as olive oil have been in use for thousand of years, and their benefits as part of a balanced diet are well understood. In fact, most vegetable oils are probably alright as part of a balanced diet and would certainly be unlikely to do any harm, except in excessive amounts, if it were not for the fact that they are chemically altered before they are used.

These oils now form a massive proportion of all the vegetable oils used worldwide, but particularly in the Western world and more especially North America. Whilst many liquid oils, such as sunflower oil, are largely unadulterated, the solid forms of vegetable oils, such as margarine, shortening, and some liquid oils, are chemically altered forms of the natural oils, commonly known as hydrogenated vegetable oils

Hydrogenation changes these oils from their natural state to a dangerous, unnatural one having major detrimental effects on health.

(3) The Health Benefits of Olive Oil.² ²See www.healingdaily.com/detoxification-diet/olive-oil.htm.

The greatest exponent of monounsaturated fat is olive oil, and it is a prime component of the Mediterranean Diet. Olive oil is a natural juice preserving the taste, aroma, vitamins, and properties of the olive fruit. Olive oil is the only vegetable oil that can be consumed as it is—freshly pressed from the fruit.

The beneficial health effects of olive oil are due to both its high content of monounsaturated fatty acids and its high content of antioxidative substances. Studies have shown that olive oil offers protection against heart disease by controlling LDL (“bad”) cholesterol levels while raising HDL (“good”) cholesterol levels.³ No other naturally produced oil has as large an amount of monounsaturated as olive oil—mainly oleic acid. ³See Keys A, Menotti A, Karvonen M J et al.: The diet and 15-year death rate in the Seven Countries Study. Am J Epidemiol 124: 903-915 (1986); Willett W C: Diet and coronary heart disease. Monographs in Epidemiology and Biostatistics 15: 341-379 (1990); World Health Organization: Diet, nutrition, and the prevention of chronic diseases. Report of a WHO Study Group. WHO Technical Report Series 797, Geneva 1990.

Olive oil is very well tolerated by the stomach. In fact, olive oil's protective function has a beneficial effect on ulcers and gastritis. Olive oil activates the secretion of bile and pancreatic hormones much more naturally than prescribed drugs. Consequently, it lowers the incidence of gallstone formation.

(4) Olive Oil and Heart Disease.

Studies have shown that people who consumed 25 milliliters (ml)—about 2 tablespoons—of virgin olive oil daily for 1 week showed less oxidation of LDL cholesterol and higher levels of antioxidant compounds, particularly phenols, in the blood.⁴ ⁴See European Journal of Clinical Nutrition April 2002;56: 114-120.

But while all types of olive oil are sources of monounsaturatedfat, extra virgin olive oil, from the first pressing of the olives, contains higher levels of antioxidants, particularly vitamin E and phenols, because it is less processed.

Olive oil is clearly one of the good oils, one of the healing fats. Most people do quite well with it since it does not upset the critical omega-6 to omega-3 ratio, and most of the fatty acids in olive oil are actually an omega-9 oil that is monounsaturated.

(5) Olive Oil and Colon Cancer.

Spanish researchers suggest that including olive oil in the diet may also offer benefits in terms of colon cancer prevention.⁵ Their study results showed that rats fed diet supplemented with olive oil had a lower risk of colon cancer than those fed safflower oil-supplemented diets. In fact, the rats that received olive oil had colon cancer rates almost as low as those fed fish oil, which several studies have already linked to a reduction in colon cancer risk. ⁵See Gut 2000;46:191-199.

(6) The Types of Olive Oil.

Generally, olive oil is extracted by pressing or crushing olives. Olive oil comes in different varieties depending on the amount of processing involved. The varieties include:
Extra virgin—considered the best, least processed, comprising the oil from the first pressing of the olives.
Virgin—from the second pressing.
Pure—undergoes some processing, such as filtering and refining.
Extra light—undergoes considerable processing and only retains a very mild olive flavor.

The oil coming from the first “pressing” of the olive is extracted without using heat—a cold press—or chemicals and has no “off” flavors and is awarded “extra virgin” status. The less the olive oil is handled—the closer to its natural state—the better the oil. If the olive oil meets all the criteria, it can be designated as “extra virgin”.

“Pure” olive oil is made by adding a little extra virgin olive oil to refined olive oil. It is a lesser grade oil that is also labeled as just “olive oil” in the United States.

“Light” olive oil is a marketing concept and not a classification of olive oil grades. It is completely unregulated by any certification organizations and therefore has no real precedent to what its content should be. Sometimes, the olive oil is cut with other vegetable oils.

C. Corn Syrup.

Corn syrup—whose chemical formula is C₆H₁₂O₆—is a syrup made from corn starch and composed mainly of glucose. A series of three enzymatic reactions is used to convert the corn starch to corn syrup. Its major use is in commercially prepared foods as a sweetener and for its moisture-retaining—humectant—properties keeping foods moist and helping to maintain freshness. As a sucrose replacement, its sweetness is often insufficient and it is used in conjunction with high intensity sweeteners.

The more general term glucose syrup is often used synonymously with corn syrup, since glucose syrup is most commonly made from corn starch.⁶ Technically though, glucose syrup is any liquid starch hydrolysate of mono, di, and higher saccharides⁷ and can be made from starch from any source, of which wheat, rice, and potatoes are the most common sources. ⁶See Sugar Association Alternative Carbohydrate Sweeteners.⁷See International Starch Association Starch and Glucose Glossary.

Highfructose corn syrup (“HFCS”) is a variant in which other enzymes are used to convert some of the glucose intofructose. The resulting syrup is sweeter and more soluble.

Some foods that commonly contain corn syrup are baking and cooking ingredients, beverages, soft drinks, breads, breakfast cereals, breakfast pastries, candy bars, condiments, cookies and cakes, cough syrups, crackers, dairy, drink mixers, frozen foods, fruits and vegetables, ice creams, infant formula, jams, jellies and syrups, meats, pastries, salad dressings, sauces, snacks and microwavable soup.

D. Chili Powder.

Like cayenne pepper, red chili peppers are available throughout the year to add zest to flavorful dishes around the world and health to those brave enough to risk their fiery heat.

This is the plant putting fire on the tongue and maybe even a tear in the eye when eating spicy Mexican, simmering Szechuan, smoldering Indian, or torrid Thai food. Chili peppers belong to the family of foods bearing the Latin name Capsicum. (1) The Health Benefits of Chili Powder.⁸ ⁸See www.whfoods.com/genpage.php?pfriendly=1&tname=foodspice&dbid=29.

Dried chili pepper contains vitamin A, dietary fiber, vitamin C, potassium, and iron.

(a) Chili Powder and Inflammation.

Chili peppers contain a substance called capsaicin, which gives peppers their characteristic pungence, producing mild to intense spice when eaten. Capsaicin is a potent inhibitor of substance P, a neuropeptide associated with inflammatory processes. The hotter the chili pepper, the more capsaicin it contains. The hottest varieties include habafiero and Scotch bonnet peppers. Jalapenios are next in their heat and capsaicin content, followed by the milder varieties, including Spanish pimentos, and Anaheim and Hungarian cherry peppers.

Capsaicin is an effective treatment for sensory nerve fiber disorders, including pain associated with arthritis, psoriasis, and diabetic neuropathy. When animals injected with a substance causing inflammatory arthritis were fed a diet containing capsaicin, they had delayed onset of arthritis, and also significantly reduced paw inflammation.

(b) Chili Powder as a Natural Pain Reliever.

Topical capsaicin is a recognized treatment option for osteoarthritis pain. Several review studies of pain management for diabetic neuropathy have listed the benefits of topical capsaicin to alleviate disabling pain associated with this condition.

In a double-blind placebo controlled trial, nearly 200 patients with psoriasis were given topical preparations containing either capsaicin or placebo. Patients who were given capsaicin reported significant improvement based on a severity score tracing symptoms associated with psoriasis.

(c) Chili Powder and Cardiovascular Health.

Red chili peppers, such as cayenne, have been shown to reduce blood cholesterol, triglyceride levels, and platelet aggregation, while increasing the body's ability to dissolve fibrin, a substance integral to the formation of blood clots. Cultures where hot pepper is used liberally have a much lower rate of heart attack, stroke, and pulmonary embolism.

Spicing meals with chili peppers may also protect the fats in blood from damage by free radicals—a first step in the development of atherosclerosis. In a randomized, crossover study involving 27 healthy subjects—14 women, 13 men, eating freshly chopped chili was found to increase the resistance of blood fats, such as cholesterol and triglycerides, to oxidation—free radical injury.

Subjects were randomly divided into 2 groups. For 4 weeks, half the subjects ate a freshly chopped chili blend—30 grams/day, about 1 ounce, including 55% cayenne, while the other half consumed a bland diet—no chili. After 4 weeks, the groups were crossed over for another 4 weeks. During the intervention periods, consumption of other spices, such as cinnamon, ginger, garlic, and mustard was restricted. Blood samples were obtained at the beginning of the study and after each dietary period.

After eating the chili-containing diet, the rate of oxidation—free radical damage to cholesterol and triglycerides—was significantly lower in both men and women than that seen after eating the bland diet.

In addition, after eating the chili-spiced diet, women had a longer lag time before any damage to cholesterol was seen compared to the lag time seen after eating the bland diet. In men, the chili-diet also lowered resting heart rate and increased the amount of blood reaching the heart.

(d) Chili Powder as a Decongestant.

Capsaicin not only reduces pain, but its peppery heat also stimulates secretions helping clear mucus from a stuffed up nose or congested lungs.

(e) Chili Powder as an Immunity Enhancer.

Chili peppers' bright red color signals its high content of beta-carotene or pro-vitamin A. Just two teaspoons of red chili peppers provide about 6% of the daily value for vitamin C coupled with more than 10% of the daily value for vitamin A. Often called the anti-infection vitamin, vitamin A is essential for healthy mucous membranes, which line the nasal passages, lungs, intestinal tract, and urinary tract and serve as the body's first line of defense against invading pathogens.

(f) Chili Powder as a Spread to Prostate Cancer.

Red chili peppers' capsaicin—the compound responsible for their pungent heat—stops the spread of prostate cancer cells through a variety of mechanisms.⁹ Capsaicin triggers suicide in both primary types of prostate cancer cell lines, those whose growth is stimulated by male hormones, and those not affected by them. In addition, capsaicin lessens the expression of prostate-specific antigen (“PSA”), inhibits the ability of the most potent form of testosterone, dihydrotestosterone, to activate PSA, and directly inhibits PSA transcription, causing PSA levels to plummet. ⁹See Cancer Research, Mar. 15, 2006.

The dose effective for test animals was equivalent to 400 milligrams of capsaicin, three times a week, for a man weighing about 200 pounds. After four weeks of receiving capsaicin, prostate cancer tumor growth and size decreased significantly in the animals.

(g) Chili Powder Prevents Stomach Ulcers.

Chili peppers have a bad—and mistaken—reputation for contributing to stomach ulcers. Not only do they not cause ulcers, they can help prevent them by killing bacteria—possibly ingested, while stimulating the cells lining the stomach to secrete protective buffering juices.

(h) Chili Powder and Weight Lose.

All that heat felt after eating hot chili peppers takes energy and calories to produce. Even sweet red peppers have been found to contain substances that significantly increase thermogenesis—heat production—and oxygen consumption for more than 20 minutes after they are eaten.

(i) Chili Powder Lowers Risk of Type 2 Diabetes.

Making chili pepper a frequently enjoyed spice could help reduce the risk of hyperinsulinemia—high blood levels of insulin—a disorder associated with type 2 diabetes.

Australian researchers show that the amount of insulin required to lower blood sugar after a meal is reduced if the meal contains chili pepper.¹⁰ When chili-containing meals are a regular part of the diet, insulin requirements drop even lower. ¹⁰See American Journal of Clinical Nutrition, July 2006.

Chili's beneficial effects on insulin needs get even better as body mass index (“BMI”—a measure of obesity) increases. In overweight people, not only do chili-containing meals significantly lower the amount of insulin required to lower blood sugar levels after a meal, but chili-containing meals also result in a lower ratio of C-peptide/insulin, an indication that the rate at which the liver is clearing insulin has increased.

The amount of C-peptide in the blood also shows how much insulin is being produced by the pancreas. The pancreas produces proinsulin—which splits into insulin and C-peptide when secreted into the bloodstream. Each molecule of proinsulin breaks into one molecule of C-peptide and one molecule of insulin, so less C-peptide means less insulin has been secreted into the bloodstream.

In the study—which involved 36 subjects aged 22-70 years—the effects of three interventions were evaluated. Subjects were given a bland meal after a bland diet containing no spices, a chili-containing meal after a bland diet, and finally, a chili-containing meal after a chili-containing diet. A palatable chili flavoring, not pure capsaicin—the active component in chili—was used.

Blood sugar rose similarly after all three interventions, but insulin rose the most after the bland meal after a bland diet and the least after the chili-containing meal after a chili-rich diet.

The maximum increases in insulin after the bland diet followed by a chili-containing meal were 15% lower than after the bland meal following a bland diet, and 24% lower after the chili-containing meal after a chili-rich diet compared to the chili-containing meal after the bland diet.

C-peptide blood levels also increased the most after the bland meal after a bland diet and the least after the chili-containing meal after a chili-rich diet, showing the least insulin was secreted after the chili-rich diet and meal.

In addition, the C-peptide/insulin ratio was highest after the chili-containing meal after a chili-rich diet, indicating an increase in the liver's ability to clear insulin.

Besides capsaicin, chilies contain antioxidants, including vitamin C and carotenoids, which might also help improve insulin regulation.

Less insulin is required and the insulin will be used more effectively

E. Red Pepper.

(1) The Key Benefits of Red Pepper.¹¹ ¹¹See www.health24.com/dietnfood/healthy_foods/15-18-20-156.asp.

Red peppers are an excellent source of vitamin C, contain high antioxidant levels, and are linked to a reduced risk of heart disease.

Red pepper contains carotenes, niacin, vitamin C, vitamin E, and fibre.

F. Salt.

(1) Salt and Health.¹² ¹²See www.saltinstitute.org/28.html.

Salt is essential not only to life, but to good health. It's always been that way. Human blood contains 0.9% salt as sodium chloride—the same concentration as found in United States Pharmacopeia (“USP”) sodium chloride irrigant commonly used to cleanse wounds.

Salt maintains the electrolyte balance inside and outside of cells. Routine physical examinations measure blood sodium for clues to personal health. Most salt comes from foods, some from water. Inadequate salt can be problematic. Doctors often recommend replacing water and salt lost in exercise and when working outside. Wilderness hikers know the importance of salt tablets to combat hyperthermia. Oral rehydration involves replacing both water and salt. Oral Rehydration Therapy (“ORT”) has been termed, by the British Medical Journal, “the most important medical advance this [20^{th}] century.”

Expectant mothers are advised to get enough salt. Increased salt intakes have been used successfully to combat Chronic Fatigue Syndrome. The unique microclimate of salt mines is a popular way to treat asthma, particularly in Eastern Europe.

Testing the salinity of perspiration is a good test for cysticfibrosis. Scientists suspect that cysticfibrosis is caused by a deformed protein preventing chloride outside cells from attracting needed moisture. And, iodized salt is the choice of public health professionals to combat iodine deficiency, has been fortified to battle other diseases like lymphatic filariasis, and is considered “the first antibiotic”.

Chloride is also essential to good health.

G. Garlic.

(1) Health Benefits and Uses of Garlic.¹³ ¹³See www.garlic-central.com/garlic-health.html.

Garlic health benefits and medicinal properties have long been known.¹⁴ Garlic has long been considered a herbal “wonder drug”, with a reputation in folklore for preventing everything from the common cold and flu to the Plague. It has been used extensively in herbal medicine, such as phytotherapy and sometimes spelt phitotherapy. Raw garlic is used by some to treat the symptoms of acne, and there is some evidence that it can assist in managing high cholesterol levels. It can even be effective as a natural mosquito repellent. ¹⁴See Health Effects of Garlic: American Family Physician.

In general, a stronger tasting clove of garlic has more sulphur content and hence more medicinal value. Some people have suggested that organically grown garlic tends towards a higher sulphur level and hence greater benefit to health.

Modern science has shown that garlic is a powerful antibiotic, albeit broad-spectrum rather than targeted. The body does not appear to build up resistance to the garlic, so its positive health benefits continue over time.

(2) Garlic as a Healthy Antioxidant.

Studies¹⁵ have shown that garlic—especially aged garlic—can have a powerful antioxidant effect. Antioxidants help to protect the body against damaging “free radicals”. ¹⁵See Antioxidant Activity of Allicin, an Active Principle in Garlic.

(3) The Medicinal Ingredients of Garlic.

There are two main medical ingredients producing the garlic health benefits, namely, allicin and diallyl sulphides.

H. Onions.¹⁶ ¹⁶www.whfoods.com/genpage.php?pfriendly=1&tname=foodspice&dbid=45.

Yellow storage onions are available throughout the year but sweet varieties have a much more limited growing season and are available only a few months out of the year.

(1) The History of Onions.

The word onion comes from the Latin word unio for “single,” or “one,” because the onion plant produces a single bulb, unlike its cousin, the garlic, that produces many small bulbs. The name also describes the union—also from unio—of the many separate, concentrically arranged layers of the onion.

Onions are native to Asia and the Middle East and have been cultivated for over five thousand years. Onions were highly regarded by the Egyptians. Not only did they use them as currency to pay the workers who built the pyramids, but they also placed them in the tombs of kings, such as Tutankhamen, so that they could carry these gifts bestowed with spiritual significance with them to the afterlife.

Onions have been revered throughout time not only for their culinary use, but also for their therapeutic properties. As early as the 6th century, onions were used as a medicine in India. While they were popular with the ancient Greeks and Romans, they were oftentimes dressed with extra seasonings since many people did not find them spicy enough. Yet, it was their pungency that made onions popular among poor people throughout the world who could freely use this inexpensive vegetable to spark up their meals.

Onions were an indispensable vegetable in the cuisines of many European countries during the Middle Ages and later even served as a classic healthy breakfast food. Christopher Columbus brought onions to the West Indies—their cultivation spread from there throughout the Western Hemisphere. Today China, India, the United States, Russian, and Spain are among the leading producers of onions.

(2) Health Benefits of Onions.

(a) In General.

Onions—like garlic—are members of the Allium family, and both are rich in powerful sulfur-containing compounds that are responsible for their pungent odors and for many of their health-promoting effects. Onions contain allyl propyl disulphide, while garlic is rich in allicin, diallyl disulphide, diallyl trisulfide, and others. In addition, onions are very rich in chromium, a trace mineral that helps cells respond to insulin, plus vitamin C, and numerous flavonoids, most notably, quercitin.

(b) Blood Sugar-Lowering Effects of Onions.

The higher the intake of onion, the lower the level of glucose found during oral or intravenous glucose tolerance tests. Experimental and clinical evidence suggests that allyl propyl disulfide is responsible for this effect and lowers blood sugar levels by increasing the amount of free insulin available. Allyl propyl disulfide does this by competing with insulin, which is also a disulphide, to occupy the sites in the liver where insulin is inactivated. This results is an increase in the amount of insulin available to usher glucose into cells causing a lowering of blood sugar.

In addition, onions are a very good source of chromium, the mineral component in glucose tolerance factor, a molecule that helps cells respond appropriately to insulin. Clinical studies of diabetics have shown that chromium can decrease fasting blood glucose levels, improve glucose tolerance, lower insulin levels, and decrease total cholesterol and triglyceride levels, while increasing good HDL-cholesterol levels.

Marginal chromium deficiency is common in the United States, not surprising since chromium levels are depleted by the consumption refined sugars and white flour products as well as the lack of exercise. One cup of raw onion contains over 20% of the Daily Value for this important trace mineral.

(c) The Cardiovascular Benefits of Onions.

The regular consumption of onions has like garlic been shown to lower high cholesterol levels and high blood pressure, both of which help prevent atherosclerosis and diabetic heart disease, and reduce the risk of heart attack or stroke. These beneficial effects are likely due to onions' sulfur compounds, its chromium, and its vitamin B6, which helps prevent heart disease by lowering high homocysteine levels, another significant risk factor for heart attack and stroke. Onions have been singled out as one of the small number of vegetables and fruits contributing to the significant reduction in heart disease risk seen in a meta-analysis of seven prospective studies. Of the more than 100,000 individuals who participated in these studies, those who diets most frequently included onions, tea, apples, and broccoli—the richest sources of flavonoids—gained a 20% reduction in their risk of heart disease.

(d) Onions Support Gastrointestinal Health.

The regular consumption of onions—as little as two or more times per week—is associated with a significantly reduced risk of developing colon cancer. Onions contain a number of flavonoids—the most studied of which being quercitin—has been shown to halt the growth of tumors in animals and to protect colon cells from the damaging effects of certain cancer-causing substances. Cooking meats with onions may help reduce the amount of carcinogens produced when meat is cooked using high heat methods.

Quercitin—an antioxidant in onions—and curcumin—a phytonutrient found in the curry spice turmeric—reduce both the size and number of precancerous lesions in the human intestinal tract.¹⁷ ¹⁷See Clinical Gasteroenterology and Hepatology.

Five patients with an inherited form of precancerous polyps in the lower bowel known as familial adenomatous polyposis (“FAP”) were treated with regular doses of curcumin and quercitin over an average of six months. The average number of polyps dropped 60.4%, and the average size of the polyps that did develop dropped by 50.9%.

FAP runs in families and is characterized by the development of hundreds of polyps—colorectal adenomas—and, eventually, colon cancer. Recently, nonsteroidal anti-inflammatory drugs—NSAIDs, such as aspirin, ibuprofen—have been used to treat some patients with this condition, but these drugs often produce significant side effects, including gastrointestinal ulcerations and bleeding.¹⁸ ¹⁸See Francis M. Giardiello, M.D. at the Division of Gasteroenterology, Johns Hopkins University.

Previous observational studies in populations consuming large amounts of curry—as well as animal research—have strongly suggested that curcumin—one of the main ingredients in Asian curries—might be effective in preventing and/or treating cancer in the lower intestine. Similarly, quercitin—an anti-oxidant flavonoid found in a variety of foods including onions, green tea, and red wine—has been shown to inhibit growth of colon cancer cell lines in humans and abnormal colorectal cells in animals.

In this study, a decrease in polyp number was observed in four of five patients at three months and four of four patients at six months.

Each patient received 480 mg of curcumin and 20 mg of quercitin orally 3 times a day for 6 months. Although the amount of quercitin was similar to what many people consume daily, the curcumin consumed was more than would be provided in a typical diet because turmeric only contains on average 3-5% curcumin by weight. While simply consuming curry and onions may not have as dramatic an effect as was produced in this study, this research clearly demonstrates that liberal use of onions and turmeric and onions can play a protective role against the development of colorectal cancer.

(e) Onions and Garlic Protect Against Many Cancers.

Making onion and garlic a staple in a healthy way of eating may greatly lower the risk of several common cancers, suggests a large data set of case-control studies from Southern European populations.¹⁹ ¹⁹See Galeone C, Pelucchi C et al, American Journal of Clinical Nutrition.

Study participants consuming the most onions showed an 84% reduced risk for cancer of the oral cavity and pharynx, 88% reduced risk for esophageal cancer, 56% reduced risk for colorectal cancer, 83% reduced risk for laryngeal cancer, 25% reduced risk for breast cancer, 73% reduced risk for ovarian cancer, 71% reduced risk for prostate cancer, and 38% reduced risk for renal cell cancer, compared to those eating the least onions.

Similarly, those eating the most garlic had a 39% reduced risk for cancer of the oral cavity and pharynx, 57% reduced risk for esophageal cancer, 26% reduced risk for colorectal cancer, 44% reduced risk for laryngeal cancer, 10% reduced risk for breast cancer, 22% reduced risk for ovarian cancer, 19% reduced risk for prostate cancer, and 31% reduced risk for renal cell cancer, compared to those eating the least garlic.

(f) Onions Boosts Bone Health.

Milk isn't the only food boosting bone health. Onions also help maintain healthy bones, suggests a study published in the Journal of Agricultural and Food Chemistry.

A compound newly identified in onions with the long complex name of gamma-L-glutamyl-trans-S-J-propenyl-L-cysteine sulfoxide (“GPCS”) inhibits the activity of osteoclasts—the cells that break down bone. The more GPCS given in this animal study, the more the bone resorptive—breakdown—action of osteoclasts was inhibited.

Onions may be especially beneficial for women who are at increased risk for osteoporosis as they go through menopause. Fosamax (Alendronate), the drug typically prescribed to prevent excessive bone loss, works in a similar manner, by destroying osteoclasts, so they do not break down bone.

(g) Anti-Inflammatory and Anti-Bacterial Activity of Onions.

Several anti-inflammatory agents in onions render them helpful in reducing the severity of symptoms associated with inflammatory conditions, such as the pain and swelling of osteo- and rheumatoid arthritis, the allergic inflammatory response of asthma, and the respiratory congestion associated with the common cold. Both onions and garlic contain compounds that inhibit lipoxygenase and cyclooxygenase—the enzymes generating inflammatory prostaglandins and thromboxanes—thus markedly reducing inflammation. Onions' anti-inflammatory effects are due not only to their vitamin C and quercitin, but to other active components called isothiocyanates. These compounds work synergistically to spell relief from inflammation. In addition, quercitin and other flavonoids found in onions work with vitamin C to help kill harmful bacteria, making onions an especially good addition to soups and stews during cold and flu season.

Onions are a major source of both phenols and flavonoids, phytonutrients that numerous population studies have shown are protective against both cardiovascular disease and cancer.

I. Lemon juice.²⁰ ²⁰See www.ezinearticles.com/?lemon-juice-health-bebefits&id=120819&opt=print.

(1) In General.

Lemonade is known to have been used as a refreshing drink since the time of the Moguls. Modem investigations have tended to support this use, the essential oil being very good for cooling the body. This use can be extended to the employment of lemon juice with water and sugar as the best drink to take when you have a fever.

When the temperature of the body is high—whether from the effects of the sun or from the results of illness—it is necessary to take regular drinks in order to prevent dehydration. Sugar is not normally a desirable part of a healthy diet, nevertheless it has its part to play with lemon, and although there is no doubt that the addition of honey if available is very much to be preferred.

The high vitamin C content of the lemon has been used for hundreds of years to ward off scurvy among sailors and travelers. There is little sodium, so the fruit is good as a flavoring for those on a low salt diet.

The pulp left from the juicing is excellent for the skin and can also soothe the bites and stings of insects. If equal parts of toilet water and of glycerin are added to the residue, the mixture can be made to keep the hands smooth.

Lemon when vaporized will neutralize the bacteria of meningococcus, typhoid, pneumococcus, and staphylococcus in from 15 to 180 minutes.²¹ Lemon juice added to raw oysters before eating them destroys 92% of the bacteria present within 15 minutes.²² This information is relevant to the idea that lemon Juice is a most important therapy to be used in all cases of infection of the respiratory tract and as a general tonic. ²¹See Doctors Morel and Rochaix.²²See Charles Richet.

(2) The Benefits of Lemon.²³ ²³See www.oohoi.com/natural%20remedy/everyday-food/lemon.htm.

This is another fruit that has been known for its therapeutic properties for generations. It is also a root of any home remedy and is normally used to help the stomach because it has special cleansing effect.

Lemon is one of the fruits that strengthens the immune system. Lemon juice will relieve the symptoms as well as halt the progress of the flu, colds, and most infections because of its antibacterial and antiviral properties.

Lemon act as blood purifier, improves the body's ability to get rid of toxins and is excellent in fighting disease that's related to infection, is mother nature's version of insecticides helping to repel mosquitoes and flies and antiseptics. Because of its styptics property, it is said that lemon could be applied on cuts to stop bleeding.

Drinking lemon juice is useful for people with heart problem because of its high potassium content.

(3) The Uses of Lemon.
Fresh lemon juice cleanses the system.
Use pure lemon juice on wasp and bee stings to relieve pain.
Lemon juice mixed with olive oil may help to dissolve gallstones.
Regular intake of fresh lemons may be useful in treating cases of kidney stones.

C. The Conclusions.

(1) Vegetable Oil.
Used in aromatherapy.
Forms the basis for virtually all fragrances and perfumes widely available.
Used as a component of salad dressing.
Used in batter for cakes and pastries.
Used for frying.
Determined healthier than fats derived from animals.

(2) Olive Oil.
Preserves taste, aroma, vitamins, and properties of the olive fruit.
Consumable as is, i.e., freshly pressed from the fruit.
Contains high content of monounsaturated fatty acids.
Contains high content of antioxidative substances, particularly vitamin E and phenols.
Protects against heart disease by lowering LDL cholesterol levels while raising HDL cholesterol levels.
Contains large amount of monounsaturated fats—mainly oleic acid.
Tolerated well by the stomach.
Protective function provides a beneficial effect on ulcers and gastritis.
Activates secretion of bile and pancreatic hormones much more naturally than prescribed drugs thereby lowering the incidence of gallstone formation.
Does not upset the critical omega-6 to omega-3 ratio.
Contains fatty acids that are an omega-9 oil that is monounsaturated.
Prevents colon cancer.

(3) Corn Syrup.
Used as a sweetener
Contains moisture-retaining—humectant—properties to keep food moist and help to maintain freshness.
Used as a sucrose replacement.

(4) Chili Powder.
Adds zest to flavorful dishes.
Contains vitamin A, dietary fiber, vitamin C, potassium, and iron.
Functions as an anti-inflammatory agent by inhibiting substance P—a neuropeptide associated with inflammatory processes.
Used to treat sensory nerve fiber disorders, including pain associated with arthritis, psoriasis, and diabetic neuropathy.
Delays onset of arthritis.
Treatment option for osteoarthritis pain and diabetic neuropathy.
Reduces blood cholesterol, triglyceride levels, and platelet aggregation, while increasing the body's ability to dissolve fibrin—a substance integral to the formation of blood clots.
Lowers rate of heart attack, stroke, and pulmonary embolism.
Protects the fats in blood from damage by free radicals—a first step in the development of atherosclerosis.
Increases the resistance of blood fats, such as cholesterol and triglycerides, to oxidation—free radical injury.
Lowers resting heart rate.
Increases amount of blood reaching the heart.
Used as a decongestant.
Enhances immunity due to high content of beta-carotene or pro-vitamin A.
Stops spread of prostate cancer cells through a variety of mechanisms by plummeting PSA levels.
Prevents stomach ulcers by killing bacteria—possibly ingested, while stimulating cells lining the stomach to secrete protective buffering juices.
Causes weight lose.
Lowers risk of type 2 diabetes.
Helps reduce the risk of hyperinsulinemia—high blood levels of insulin—a disorder associated with type 2 diabetes.
Lowers insulin requirements.
Lowers ratio of C-peptide/insulin—an indication that the rate at which the liver is clearing insulin has increased.
Raises C-peptide/insulin ratio indicating an increase in the liver's ability to clear insulin.
Adds antioxidants, including vitamin C and carotenoids, which might also help improve insulin regulation.
Decreases amount of insulin required.
Uses insulin more effectively.

(5) Red Pepper.
Provides an excellent source of vitamin C.
Contains high antioxidant levels.
Linked to a reduced risk of heart disease.
Contains carotenes, niacin, vitamin E, and fibre.

(6) Salt.
Acts as an irrigant commonly used to cleanse wounds.
Maintains electrolyte balance inside and outside of cells.
Combats hyperthermia.
Used to combat Chronic Fatigue Syndrome.
Used to treat asthma.
Used to test for cysticfibrosis.
Combats iodine deficiency.
Battles lymphatic filarisis.

(7) Garlic.
Used extensively in herbal medicine, such as phytotherapy and sometimes spelt phitotherapy.
Used to treat the symptoms of acne.
Assists in managing high cholesterol levels.
Used as a natural mosquito repellent.
Contains high sulphur level.
Used as a powerful antibiotic.
Used as an antioxidant to protect the body against damaging “free radicals”.
Contains allicin and diallyl sulphides.

(8) Onions.
Contains sulfur-containing compounds, such as allyl propyl disulphide.
Contains chromium—a trace mineral helping cells respond to insulin.
Contains vitamin C.
Contains numerous flavonoids, most notably quercitin.
Contains allyl propyl disulfide responsible for lowering blood sugar levels by increasing amount of free insulin available.
Contains chromium—the mineral component in glucose tolerance factor.
Improves glucose tolerance.
Lowers insulin levels.
Decreases total cholesterol and triglyceride levels, while increases good HDL-cholesterol levels.
Lowers high cholesterol levels to help prevent atherosclerosis and diabetic heart disease and thereby reduce the risk of heart attack or stroke.
Lowers high blood pressure to help prevent atherosclerosis and diabetic heart disease and thereby reduce the risk of heart attack or stroke.
Contains vitamin B6 to lower high homocysteine levels.
Contains flavonoids including quercitin to reduce risk of developing colon cancer.
Reduces amount of carcinogens produced when meat is cooked using high heat methods.
Contains quercitin to reduce both the size and number of precancerous lesions in the human intestinal tract.
Prevents and/or treats cancer in the lower intestine.
Inhibits growth of colon cancer cell lines.
Reduces risk for cancer of the oral cavity and pharynx.
Reduces risk for esophageal cancer.
Reduces risk for colorectal cancer.
Reduces risk for laryngeal cancer.
Reduce risk for breast cancer.
Reduces risk for ovarian cancer.
Reduces risk for prostate cancer.
Reduces risk for renal cell cancer.
Helps maintain healthy bones.
Contains gamma-L-glutamyl-trans-S-1-propenyl-L-cysteine sulfoxide to inhibit the activity of osteoclasts—the cells that break down bone.
Beneficial for women who are at increased risk for osteoporosis as they go through menopause.
Functions as an anti-inflammatory for treatment of pain and swelling of osteo- and rheumatoid arthritis, the allergic inflammatory response of asthma, and the respiratory congestion associated with the common cold.
Functions as an anti-bacterial activity.
Contains compounds that inhibit lipoxygenase and cyclooxygenase—enzymes generating inflammatory prostaglandins and thromboxanes.
Protects against both cardiovascular disease and cancer.

(9) Lemon Juice.
Cools the body.
Contains vitamin C to ward off scurvy among sailors and travelers.
Excellent for the skin.
Soothes bites and stings of insects.
Keeps hands smooth.
Naturalizes bacteria of meningococcus, typhoid, pneumococcus, and staphylococcus.
Destroys bacteria present in oysters.
Used to treat infection of the respiratory tract.
Helps stomach because of its special cleansing effect.
Strengthens immune system.
Relieves symptoms as well as halt progress of flu, colds, and most infections because of its antibacterial and antiviral properties.
Acts as a blood purifier by improving the body's ability to get rid of toxins.
Helps to repel mosquitoes and flies.
Stops bleeding.
Useful for people with heart problems because of its high potassium content.
Cleanses the system.
Used on wasp and bee stings to relieve pain.
Helps to dissolve gallstones.
Treats kidney stones.

It will be understood that each of the elements described above or two or more together may also find a useful application in other types of constructions differing from the types described above.

While the embodiments of the present invention have been illustrated and described as embodied in a health-enhancing ethnic salad dressing, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A health-enhancing ethnic salad dressing, comprising:
a) vegetable/olive oil;
b) corn syrup;
c) chili powder;
d) crushed red pepper;
e) salt;
f) dried garlic;
g) dried onion; and
h) lemon juice concentrate.

2. The dressing of claim 1, further comprising:
i) water;
j) distilled vinegar; and
k) spices.
